(19) United States
(12) Patent Application Publication
(10) Pub. No.: US 2006/0104780 A1
(43) Pub. Date: May 18, 2006

(54) Industrial truck having an enlarged driver's field of vision

(76) Inventor: Carsten Schottke, Moosburg (DE)

Correspondence Address: EDWARDS & ANGELL, LLP, P.O. BOX 55874, BOSTON, MA, 02205, US

(21) Appl. No.: 11/201,919

(22) Filed: Aug. 11, 2005

(30) Foreign Application Priority Data
Aug. 19, 2004 (DE) 10 2004 040 298.1

(51) Int. Cl. B66F 9/06

(52) U.S. Cl. 414/592

(57) ABSTRACT

The present invention relates to an industrial truck having a load displacement means (58) bearing a load-accommodating means such that it can be displaced, the industrial truck having, as the drive for displacing the load-accommodating means, a piston/cylinder unit (12) which comprises as components a piston (16) which can be extended out of a cylinder (14) and withdrawn into this cylinder, a flexible force transmission means being provided for the purpose of transmitting a force from the piston/cylinder unit (12) to a moveable component (62, 64) of the load displacement means (58) or to the load-accommodating means itself and, for the purpose of deflecting said force transmission means, at least one deflection means (26, 28) for the force transmission means which deflects the force transmission means about a deflection axis (M34, M40) being connected to one of the components: piston and cylinder. In accordance with the invention, at least one section of the deflection means (26, 28), preferably the entire deflection means (26, 28), lies in the region of longitudinal extent (E) of the piston/cylinder unit (12).

The present invention relates to industrial trucks in general and relates in particular to industrial trucks having a driver's platform which can be displaced together with the load-accommodating means.

Such industrial trucks are sufficiently well known in the prior art.

In industrial trucks of this type, a series of components of the industrial truck are located in the field of vision of the driver in the forward direction of travel of the industrial truck in which the industrial truck is moved for the majority of its travelling time, and these components impede the vision of the industrial truck driver. These components include structural elements of load displacement means, movement drives for load displacement means, force transmission means between the movement drives and associated moving components of the industrial truck, electrical lines, hydraulic and possibly pneumatic lines etc.

One object of the present invention is to provide an industrial truck in which the driver has a field of vision in the forward direction of travel which is restricted as little as possible.

In accordance with a first aspect of the present invention, the invention relates to an industrial truck having a load displacement means bearing a load-accommodating means such that it can be displaced, the industrial truck having, as the drive for displacing the load-accommodating means, a piston/cylinder unit which comprises as components a piston which can be extended out of a cylinder and withdrawn into this cylinder, a flexible force transmission means being provided for the purpose of transmitting a force from the piston/cylinder unit to a moveable component of the load displacement means or to the load-accommodating means itself and, for the purpose of deflecting said force transmission means, at least one deflection means for the force transmission means which deflects the force transmission means about a deflection axis being connected to one of the components: piston and cylinder.

One longitudinal end of the flexible force transmission means is generally fixed on the component of the industrial truck bearing the piston/cylinder unit, while the respective other longitudinal end of the flexible force transmission means is fixed on a further component which can move in relation to the component bearing the piston/cylinder unit. A relative movement of the piston and cylinder of the piston/cylinder unit then leads to a transmitted movement of the further component in relation to the movement of the component, bearing the deflection means, of the piston/cylinder unit, depending on the type of deflection, for example on the degree of deflection angle.

In this case, for example, a piston/cylinder unit is known in the prior art in which a so-called head piece is fitted to the free longitudinal end of the piston rod, deflection rollers of said head piece for the purpose of deflecting slat chains in the longitudinal direction of the piston/cylinder unit being arranged at a distance away from the piston/cylinder unit, it being possible for the known chain deflection rollers to be rotated about a deflection axis which is orthogonal with respect to the piston/cylinder unit. Such known assemblies comprising a piston/cylinder unit and a head piece therefore have an overall length which is extended by the diameter of the deflection rollers and a section of their bearing means, with the result that the piston/cylinder unit in all probability protrudes into the field of vision of an industrial truck driver with the deflection rollers.

The first aspect of the present invention has the aim of removing flexible force transmission means and their deflection means as far away as possible from the field of vision of the driver.

In accordance with the above-described first aspect of the present invention for the purpose of enlarging the driver's field of vision, the deflection means for a force transmission means for the purpose of transmitting a force from the piston/cylinder unit to a moving component of the load displacement means is provided such that at least one section of the deflection means lies in the region of longitudinal extent of the piston/cylinder unit. As a result, the overall length of an assembly comprising the piston/cylinder unit and the deflection means is shorter than in the prior art, with the result that it takes up less space and thus protrudes to a lesser extent into the driver's field of vision given the same arrangement on the industrial truck.

In the sense of the present application, “lying in the region of longitudinal extent” is intended to apply to a section of the deflection means when an imaginary radial beam orthogonal with respect to the longitudinal axis of the piston/cylinder unit, starting from the longitudinal axis, passes through or at least touches both either the piston or the cylinder of the piston/cylinder unit and the section of the deflection means. In other words, the piston/cylinder unit can be conceived as a geometric cylinder which is radially and infinitely extended, in accordance with the basic concept of the first aspect of the present invention, at least one section of the deflection means protruding into the imaginary cylinder.

In this case, it is advantageous for achieving an overall length which is as short as possible for an assembly comprising the piston/cylinder unit and the deflection means if a section of the deflection means which is as large as possible lies in the region of longitudinal extent of the piston/cylinder unit. The entire deflection means is preferably arranged in the region of longitudinal extent of the piston/cylinder unit.

In accordance with a further development of the invention, the deflection means can be arranged for the purpose of achieving an overall length of the assembly comprising the piston/cylinder unit and the deflection means which is as short as possible such that the imaginary deflection axis, extended in the direction towards the piston/cylinder unit, of the deflection means for the force transmission means crosses or intersects the piston/cylinder unit.

“Intersect” is in this case intended to mean that the imaginary deflection axis extended towards the piston/cylinder unit passes through or at least touches a component of the piston/cylinder unit, for example the piston and/or the cylinder. “Cross” is intended to mean that the imaginary deflection axis extended towards the piston/cylinder unit passes by the piston/cylinder unit at a distance and orthogonally with respect to the longitudinal axis of the piston/cylinder unit without passing through it, a projection of the extended imaginary deflection axis in a projection direction which is orthogonal with respect to the deflection axis and orthogonal with respect to the longitudinal axis of the piston/cylinder unit intersecting a projection of the piston/cylinder unit in the same projection direction.

In this case, it is preferred for the at least one deflection means to be provided such that the deflection axis runs substantially orthogonally with respect to the longitudinal axis of the piston/cylinder unit. That is to say, since the piston can move in relation to the cylinder along the longitudinal axis mentioned, a deflection axis which is orthogonal with respect to the longitudinal axis of the piston/cylinder unit can ensure that the flexible force transmission means can run parallel to the longitudinal axis of the piston/cylinder unit such that as large a proportion as possible of the force produced by the piston/cylinder unit can be transmitted by the force transmission means as a tensile force to the moving component, associated therewith, of the industrial truck.

An assembly which is easy to install comprising the piston/cylinder unit and the force transmission deflection means can be obtained by a head piece having a holding means for the purpose of holding the deflection means for the force transmission means being provided at that free longitudinal end of the piston which protrudes from the cylinder. In this case, when the deflection axis runs orthogonally with respect to the longitudinal axis of the piston/cylinder unit, it is ensured that the deflection means protrudes only slightly beyond the length of the piston/cylinder unit. If, for example, a chain deflection roller is used as the deflection means, in this arrangement the chain deflection roller protrudes beyond the overall length of the piston/cylinder unit at most with half its diameter in the longitudinal direction of said piston/cylinder unit.

The deflection means is particularly preferably arranged such that the deflection axis is offset towards the cylinder in the longitudinal direction of the piston/cylinder unit, with the result that only a very small part of the deflection means protrudes beyond the free piston end or, further preferably still, the deflection means lies completely within the longitudinal extent of the piston/cylinder unit. The latter case provides a very short assembly comprising the piston/cylinder unit and the deflection means or head piece.

For this purpose, in one design of this feature, deflection means holders can protrude parallel to the longitudinal axis of the piston/cylinder unit towards the side of the cylinder on the head piece which may comprise a substantially planar mounting plate. Such a deflection means holder can clamp the deflection means axially on one side. For reasons of deformation rigidity and in order to prevent excessive bending moments in the holder, the deflection means is preferably held at both axial ends in the direction of the deflection axis, however, such that substantially tensile forces, but no bending moments, act on the holder of the deflection means.

In order to reduce the mechanical load on the flexible force transmission means and also the piston/cylinder unit, at least two deflection means for the force transmission means are provided on two opposing sides of the piston/cylinder unit. The at least two deflection means are preferably arranged symmetrically with respect to the longitudinal axis of the piston/cylinder unit such that the bearing forces to be absorbed by the holders of the respective deflection means are of substantially the same size and are at the same distance from the longitudinal axis, with the result that the piston/cylinder unit is not subject to bending, or is hardly subject to bending, owing to the bearing forces.

As has already been mentioned above, the force transmission means may be a chain, for example a slat chain. Such chains can be guided virtually in an interlocking manner without slip in toothed wheels of complementary design. In such a case, the deflection means for the force transmission means may be a chain deflection roller, possibly a toothed chain deflection roller, in this case the axis of rotation of the chain deflection roller representing the deflection axis of the chain. In principle, however, a use of cables as flexible force transmission means for transmitting a force from a drive to a driven component of the load displacement means is also conceivable.

A further aspect of the present invention, which can be realized on an industrial truck in addition or as an alternative to the aspect described above, relates to the guidance of cables on the industrial truck, in particular of a cable by means of which control commands can be transmitted from a control panel, for example on a driver's platform, to a control unit on the industrial truck frame. This should not rule out the possibility of further signals or else drive energy being transmitted in both directions via such a cable. The guidance of such cables is of great importance in particular in the case of industrial trucks having a moving driver's platform, in particular one which can be lifted or lowered, since in this case the distance between the control panel or driver's platform and the control unit fixed to the frame changes during operation.

To be more precise, this aspect of the present invention relates to an industrial truck having a lifting mast which bears a load-accommodating means such that it can be displaced and comprises a lifting stand fixed to the industrial truck frame and at least one lifting frame which is guided on the lifting stand and can be displaced in relation to said lifting stand in the longitudinal direction thereof, a cable for the purpose of transmitting control signals running between a control unit fixed to the industrial truck frame and an operating unit which is provided on a driver's platform which is guided on the lifting frame such that it can move in relation to said lifting frame.

In the case of such industrial trucks, until now the control cable has finally been guided downwards, i.e. in the direction towards the standing area for the industrial truck, to the driver's platform on an upper transverse end bar of a lifting stand bearing a driver's platform such that it can be displaced. The cable therefore passes through part of the field of vision of the driver.

On the other hand, the field of vision of the driver can largely be kept free of this cable if the deflection means for the force transmission means is designed such that the cable, starting from its end fixed to the industrial truck frame, runs upwards to a first cable deflection point on the lifting stand, from there downwards to a second cable deflection point on the lifting frame and from there upwards to the driver's platform.

The same concept of the invention can also be applied to an industrial truck having a lifting mast comprising a lifting stand and two lifting frames guided thereon such that they can move, to be more precise on an industrial truck having a lifting mast which bears a load-accommodating means such that it can be displaced and comprises a lifting stand fixed to the industrial truck frame, a first lifting frame which is guided on the lifting stand and can be displaced in relation to said lifting stand in the longitudinal direction thereof, and a second lifting frame which is guided on the first lifting frame in relation to said first lifting frame so as to move substantially in the longitudinal direction of the lifting stand, a cable for the purpose of transmitting control signals running between a control unit fixed to the industrial truck frame and an operating unit which is provided on a driver's platform which is guided on the second lifting frame such that it can move in relation to said second lifting frame substantially in the longitudinal direction of the lifting stand.

In the case of such an industrial truck, the cable can advantageously be arranged without the field of vision of the driver being impaired to a notable extent if the cable, starting from its end fixed to the industrial truck frame, runs upwards to a first cable deflection point on the lifting stand, from there downwards to a second cable deflection point on the first lifting frame and from there upwards to a third deflection point on a movement part which moves in a fixed movement relationship with respect to the driver's platform and from there to the driver's platform.

“Upwards” in the sense of the present application is intended in this case to be understood as meaning that the running direction of the cable section has a component pointing away from the standing area for the industrial truck. Correspondingly, the running direction of a cable section running “downwards” has a component towards the standing area.

Industrial trucks having a lifting stand, a lifting frame and a driver's platform which is guided such that it can move on the lifting frame are generally designed such that the movement of the driver's platform has a fixed movement relationship with respect to the movement of the lifting frame. This movement relationship is often 2:1, with the result that the cable can be deflected through 180° at each deflection point, which makes it possible for the cable to be accommodated in meandering fashion in a very small amount of physical space.

This movement relationship is realized by selecting corresponding dimensions for the piston faces of the piston/cylinder units driving the respective components to move. The different piston/cylinder units are connected fluidically in parallel such that the same fluid pressure in the different piston/cylinder units leads to different forces.

In the second alternative mentioned, namely an industrial truck having a lifting stand, a first and a second lifting frame, the driver's platform can be guided in an extremely advantageous manner by the second lifting frame independently of movement, i.e. the driver's platform can be displaced independently of the movement of the lifting frame. The movements of the lifting frame in relation to the lifting stand, on the other hand, generally have a fixed movement relationship. This is often 2:1, with the result that the first and second lifting frames are always displaced at the same time, the second lifting frame covering twice the displacement path compared to the first lifting frame. This also in turn makes possible 180° deflections of the cable at the respective deflection points such that the held cable length can be provided in meandering fashion in a very small physical volume.

In order to prevent the cable from becoming detached from the first and/or the second deflection point, these deflection points should be arranged such that the first deflection point is positioned above the second deflection point, with respect to the industrial truck standing area, when the lifting frame has been extended completely in relation to the lifting stand.

In this case, the specific arrangement of the deflection points is otherwise freely selectable. In order to be able to use as large a displacement path as possible, it is advantageous for the first deflection point to be arranged as far up as possible on the lifting stand, preferably above the longitudinal centre of the lifting stand, particularly preferably above the lower 75% of the overall length of the lifting stand or better still above the lower 85% of the overall length of the lifting stand. This should not rule out the possibility of the deflection point being positioned on top of the lifting stand, i.e. the first deflection point being provided outside of and above the actual overall length of the lifting stand.

It is likewise advantageous for the second deflection point to be arranged as far down as possible on the (first) lifting frame, preferably below the longitudinal centre of the (first) lifting frame, particularly preferably below the upper 75% of the overall length of the (first) lifting frame or better still below the upper 85% of the overall length of the (first) lifting frame. This should likewise not rule out the possibility of the second deflection point being positioned at the bottom on the (first) lifting frame, i.e. of it being located outside of and below the actual longitudinal extent of the (first) lifting frame.

Furthermore, the name of the respective component of the lifting mast for providing the deflection points should not be associated with any restriction. The deflection point can therefore be arranged on any desired element of the designated component or on an element, for example a support, which is rigidly connected to the designated component.

In order likewise to prevent the cable from lifting off or becoming detached from the second and/or third deflection point, it is advantageous if the third deflection point is always positioned above the second deflection point.

The movement part, which bears the third deflection point, is preferably part of a piston/cylinder unit, which drives the driver's platform in relation to the second lifting frame so as to move it, particularly preferably of the piston which can move in relation to a cylinder fixed on the second lifting frame. Owing to the movement relationship, which is fixed by means of the deflection point, between the movement of a movement part, preferably a piston, of a piston/cylinder unit driving the driver's platform and the movement of the driver's platform, it is easily possible for the necessary cable requirement to be calculated in advance and for the cable always to be kept taut during operation.

A compact design which only slightly impairs the field of vision of an industrial truck driver is achieved if the movement part is the piston, which can move in relation to a cylinder fixed on the second lifting frame, of the piston/cylinder unit, a force transmission deflection means having at least one of the features described above in connection with deflection means for the force transmission means being provided on said movement part. In this case, it is particularly advantageous if the cable deflection axis of the third cable deflection point is substantially parallel to, preferably substantially colinear with respect to, the deflection axis of the deflection means for the force transmission means. Owing to the parallelism it is ensured that the cable is only subjected to a tensile load when the piston moves, i.e. no shearing forces occur. With a colinear arrangement, the cable deflection means and the deflection means for the force transmission means can be mounted such that they can rotate, for example, on a common axis of rotation, which keeps the required number of components low.

In order to limit the tensile stress acting on the cable, tensile strain-relief devices are preferably provided at at least one longitudinal end, preferably at both longitudinal ends, of the cable. Furthermore, a further tensile strain-relief device for the cable can also be provided between two successive cable deflection points in order to prevent excessive tensile stresses acting on the cable. This tensile strain-relief device between two deflection points is primarily expedient when using a flat cable, since this flat cable under certain circumstances needs to be rotated about its longitudinal axis between two deflection points. An increase in the load owing to tensile stress, which is imparted on the cable owing to the rotation, with simultaneous fixing of the cable against rotation can be prevented or at least reduced by this tensile strain-relief device. Such a rotation of a flat cable may be particularly necessary between the second and the third deflection point.

The tensile strain-relief device may be designed, for example, such that the cable is kept in gathered form between two clamping points connected by means of at least one tension spring. If in this case a tensile stress occurs on the cable, the cable section which is gathered between the clamping points is stretched against the force of the at least one spring, with the result that to a certain extent there is a reserve stretch for the cable and thus cable breakage can be prevented.

It is particularly simple and favourable for the cable if a cable deflection roller is provided at at least one, preferably at all, of the cable deflection points. The cable can roll virtually without slip on this cable deflection roller such that hardly any wear occurs during deflection.

That which has been said above in relation to electrical cables is essentially also true for tubes for the transportation of fluid. Of particular interest in the case of industrial trucks are tubes conveying hydraulic fluid.

For this reason, the third aspect of the present invention, which can be used on an industrial truck in addition or as an alternative to the aspects mentioned above, relates to an industrial truck having a lifting mast which bears a load-accommodating means such that it can be displaced and comprises a lifting stand fixed to the industrial truck frame, a first lifting frame which is guided on the lifting stand and can be displaced in relation to said lifting stand in the longitudinal direction thereof, and a second lifting frame which is guided on the first lifting frame in relation to said first lifting frame so as to move substantially in the longitudinal direction of the lifting stand, a cylinder of a piston/cylinder unit further being fixed on the second lifting frame, and the piston which can move in relation to said cylinder being coupled so as to provide motion transfer to a driver's platform which is guided on the second lifting frame such that it can move in relation to said second lifting frame substantially in the longitudinal direction of the lifting stand, a flexible working fluid line conveying working fluid running between a fluid conveying unit fixed to the industrial truck frame and the cylinder.

In such industrial trucks, the field of vision of the industrial truck driver can be kept substantially free of being impaired by the flexible working fluid line if the working fluid line, starting from its end fixed to the industrial truck frame, runs upwards to a first line deflection point on the lifting stand, from there downwards to a second line deflection point on the first lifting frame and from there to the cylinder.

In order to explain advantageous developments of the arrangement of the working fluid line in more detail, reference is made to that which has been mentioned above for the arrangement of the cable, since the problems relating to tubes and cables, for example as regards preventing them from being detached from deflection points, preventing excess tensile stress, arrangement of deflection points etc., substantially correspond to one another. The advantageous developments described above in relation to the cable can therefore also be used for the development for the arrangement of the working fluid line by replacing the term “cable” with “working fluid line”.

An arrangement of the cable and working fluid line which is particularly favourable as regards the field of vision owing to the fact that it barely impairs the field of vision is achieved if the lifting mast comprises in each case at least two column arrangements running parallel to one another substantially in the longitudinal direction of the lifting mast, the cable being arranged in the region of a column arrangement and the working fluid line in the region of another column arrangement, preferably hidden at least in sections by the respective column arrangements, when viewed by the industrial truck driver.

Of course, in a further preferred embodiment, only the cable or only the working fluid line can be arranged such that it is hidden at least in sections by at least one column arrangement of the lifting mast, when viewed by the industrial truck driver.

The present invention will be explained in more detail below. In the drawings:

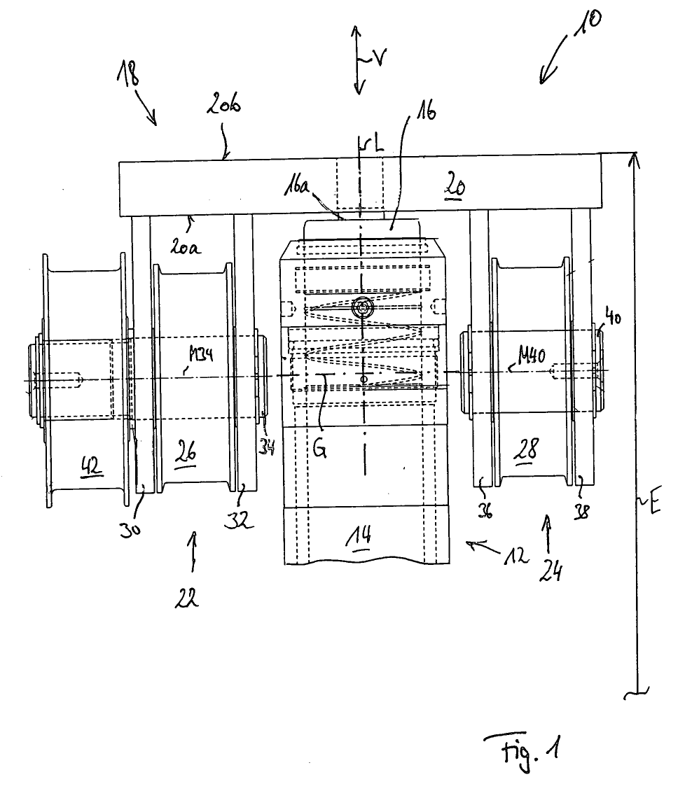

FIG. 1 shows a design of a piston/cylinder unit having a head piece and chain deflection rollers mounted thereon in accordance with the first aspect of the present invention, and

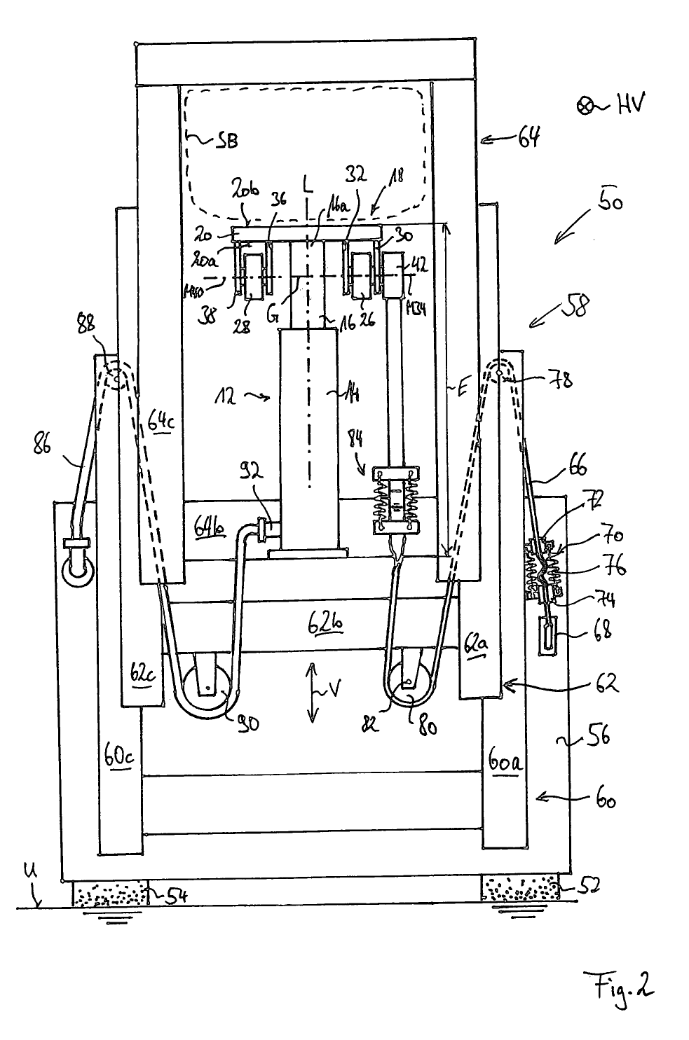

FIG. 2 shows an industrial truck according to the invention on which all three aspects of the present invention are implemented.

In FIG. 1, an assembly comprising a piston/cylinder unit and a deflection means for force transmission means is overall given the reference 10. The assembly 10 is preferably provided on an industrial truck as the drive unit for displacing a moving component of a load displacement means. The assembly 10 comprises a piston/cylinder unit 12 having a cylinder 14, which is fixed on a lifting frame 62 illustrated in FIG. 2, and a piston 16 which can be moved along the longitudinal axis L of the piston/cylinder unit 12 in relation to the cylinder 14. The ability of the piston 16 to move is indicated by the double arrow V running in the longitudinal direction L. A head piece, which is overall given the reference 18, is fixed at the free longitudinal end 16a, which protrudes out of the cylinder 14, of the piston.

The head piece 18 comprises a planar mounting plate 20, which extends substantially orthogonally with respect to the longitudinal axis L of the piston/cylinder unit 12 and on which two holders 22 and 24 for chain deflection rollers 26 and 28 are arranged. The holders 22 and 24 are arranged symmetrically with respect to a plane of symmetry, which contains the longitudinal axis L and is oriented orthogonally with respect to the plane of the drawing in FIG. 1, on opposite sides of the piston/cylinder unit 12. Since the holders 22 and 24 do not differ, merely the holder 22 is described below, it being possible for this description also to be applied to the holder 24.

The holder 22 for the chain deflection roller 26 comprises two substantially parallel discs 30 and 32 which are arranged at a distance from one another which is slightly greater than the axial dimension of the chain deflection roller 26 to be arranged between the discs 30 and 32. The substantially planar discs 30 and 32 are fitted to one side 20a of the mounting plate 20 which points towards the piston/cylinder unit 12 by means of welding, screwing, riveting or the like and protrude from said mounting plate 20 in each case substantially parallel to the longitudinal direction L of the piston/cylinder unit 12 in the direction towards the cylinder 14.

A bolt 34, which bears the chain deflection roller 26 such that it can rotate, runs between the discs 30 and 32. A bolt 40, which bears the chain deflection roller 28 such that it can rotate, likewise runs between the discs 36 and 38 of the holder 24. The bolts 34 and 40 are arranged substantially colinearly with respect to one another, i.e. the longitudinal central axis M34 of the bolt 34 and the longitudinal central axis M40 of the bolt 40 lie substantially on the same straight line. The longitudinal central axes M34 and M40 of the bolts 34 and 40, respectively, also form the deflection axes for the chains (not illustrated) deflected about the respective chain rollers 26 and 28 and the axes of rotation of the respective chain deflection rollers 26 and 28.

Reference is further made to a cable deflection roller 42, which is likewise mounted on the bolt 34 such that it can rotate about the longitudinal central axis M34 of said bolt 34 and is provided for the purpose of deflecting a cable which runs between a control panel of a driver's platform and a control device which is fixedly connected to the frame of the industrial truck. The cable deflection roller 42 may also be omitted, however.

In the cylinder, various seals, guides and ventilation slots are illustrated with dashed lines which are of no interest to the present invention and are therefore not described in any more detail.

The piston 16 ends at its free longitudinal end 16a flush with the face 20b of the mounting plate 20, with the result that it can easily be seen in FIG. 1 that the chain deflection rollers 26 and 28 are arranged completely within the region of longitudinal extent E of the piston/cylinder unit 12.

In FIG. 1, G denotes an imaginary extension of the deflection axis M34 towards the piston/cylinder unit 12. Since the deflection axes M34 and M40 are substantially colinear, the straight section G also denotes an extension of the deflection axis M40 of the deflection roller 28 towards the piston/cylinder unit 12. In the embodiment shown in FIG. 1, the extension G of the deflection axes M34 and M40 intersects, i.e. passes through, the piston/cylinder unit 12. If, in an alternative embodiment not illustrated in FIG. 1, the deflection rollers are displaced orthogonally with respect to the plane of the drawing in FIG. 1 such that the extension G of the deflection axes no longer intersects the piston/cylinder unit 12 but a projection of the extension G both orthogonal with respect to the longitudinal axis L of the piston/cylinder unit 12 and orthogonal with respect to the relevant deflection axis M34 and/or M40 intersects a projection of the piston/cylinder unit 12 in the same projection direction, in the sense of the present application this is understood to mean that it crosses the piston/cylinder unit 12. An arrangement with a deflection axis crossing in this manner is as advantageous as an arrangement with an intersecting deflection axis as regards the shortening of an assembly comprising the piston/cylinder unit 12 and the deflection rollers 26 and 28 which can be achieved.

In FIG. 2, an industrial truck according to the invention which implements all three aspects of the present invention is overall given the reference 50. The components referenced in FIG. 1 are given the same references in FIG. 2.

The industrial truck 50 has an industrial truck body 56 which can travel on wheels 52 and 54 on a base U and is built on an industrial truck frame (not illustrated) Located in the industrial truck body 56 are, inter alia, the drive assembly for driving the industrial truck 50, a hydraulic fluid tank, a hydraulic pump, a control device for driving the industrial truck drive and the hydraulic drive, a steering drive which can likewise be driven by a control device or the like.

Mounted on the industrial truck 50 is a lifting mast 58 which comprises a lifting stand 60 fixed to the industrial truck frame, a first lifting frame 62, which is guided on the lifting stand 60 such that it can move in relation to said lifting stand 60 in the direction of the double arrow V, and a second lifting frame 64 which can likewise be moved on the first lifting frame 62 in relation to said first lifting frame 62 in the direction of the double arrow V. The first lifting frame 62 and the second lifting frame 64 are driven so as to move in relation to one another by hydraulic piston/cylinder units (not illustrated). The hydraulic piston/cylinder units are in this case designed such that the second lifting frame 64 always covers twice the actuating path of the first lifting frame 62 in relation to the lifting stand 60 fixed to the industrial truck frame in the case of a lifting movement.

The piston/cylinder unit 12 described above is fixed to the cylinder 14 on the second lifting frame 64. In turn, a driver's platform (not illustrated in FIG. 2) which is positioned in front of the lifting mast 58, in the viewing direction in FIG. 2, is guided on the second lifting frame 64 such that it can move in relation to said second lifting frame 64 in the direction of the double arrow V. The piston/cylinder unit 12 forms the drive of the driver's platform. For this purpose, slat chains (not illustrated) are fixedly connected to the second lifting frame 64 with one of their longitudinal ends and to the driver's platform with the respective other longitudinal end, the profile section lying between the longitudinal ends being guided about the deflection rollers 26 and 28. In this case, one chain is used per deflection roller. Owing to the intrinsic weight of the driver's platform, the chain is always stressed.

It is thus possible for the driver's platform to be lifted by extending the piston 16 out of the cylinder 14 and to be correspondingly lowered again by withdrawing the piston, the path covered by the driver's platform always being twice as long as the path covered by the piston 16, owing to the chain transmission described.

The main direction of travel of the industrial truck 50 is characterized by an arrow HV in FIG. 2. It corresponds to the viewing direction of the viewer orthogonal with respect to the plane of the drawing in FIG. 2. As can be seen in FIG. 2, the industrial truck 50 has a particularly large field of vision SB which is delimited to the right and to the left and also at the top by the second lifting frame 64 and at the bottom substantially by the head piece 18. This field of vision SB is substantially free from force transmission means, deflection means, cables and tubes such that the driver has a view of as wide an area as possible in the main direction of travel HV.

A flat cable 66, which runs between the industrial truck body 56 and the driver's platform (not illustrated), emerges from the industrial truck body 56 at a point 68, for example from a plug which is plugged into a corresponding plug socket on the industrial truck.

In a manner known per, the cable 66 is provided with a tensile strain-relief device 70 close to the exit point 68. For this purpose, the cable is clamped with two clips 72 and 74, the two clips 72 and 74 being connected to tension springs 76. The cable length, clamped between the clips 72 and 74, of the cable 66 is longer than the tension springs 76 in the relaxed state. As a result, the cable 76 can be subjected to tensile force against the force of the springs 76 without there being a risk of cable breakage.

From the exit point 68 out of the industrial truck body 56, the cable 66 runs upwards to a first cable deflection roller 78 which is arranged on the lifting frame 60. The arrangement can take place at a suitable point on the lifting frame. In the present case, the cable deflection roller 78 is arranged on a column arrangement 60a of the lifting stand 60.

As is indicated by the dashed lines, the cable 66 is located behind the lifting mast 58, when viewed by the driver on the driver's platform, with the result that it is hidden by the lifting mast 58 and the vision of the driver is not impaired.

From the first cable deflection roller 78, the cable 66 runs, deflected through almost 180°, downwards to a second cable deflection roller 80 which is arranged on the first lifting frame 62 such that it can rotate about an axis 82. The second cable deflection roller 80 can be arranged on a column arrangement 62a of the first lifting frame 62, as is the first cable deflection roller 78. In the example illustrated, the second deflection roller, however, is connected to a transverse strut 62b of the first lifting frame.

From the second cable deflection roller 80, the cable runs upwards again, after a deflection through a further approximately 180°, the flat ribbon cable being rotated through approximately 90° about its longitudinal axis in order for it to approach the third cable deflection roller 42 which has already been described in connection with FIG. 1. This rotation is fixed with the aid of a further tensile strain-relief device 84 which substantially corresponds to the tensile strain-relief device 70. In this case, the lower clip in FIG. 2 of the tensile strain-relief device 84 is fixed to a transverse support 64b of the second lifting frame 64 such that the 90° rotation of the flat ribbon cable is ensured. Alternatively, a cable having a round, in particular a circular-round, cross section can be used. In this case, it would not be necessary for the rotation through 90° to be secured mechanically, with the result that the second tensile strain-relief device 84 does not need to be provided.

From the second tensile strain-relief device 84, the cable 66 runs further upwards and is deflected in turn through approximately 180° at the third cable deflection roller 42. The incoming stretch of cable to the roller 42 is behind the roller axis of rotation M34 in FIG. 2, and the outgoing stretch of cable away from the roller 42 is correspondingly in front of said roller axis of rotation M34.

The axes of rotation of the first two cable deflection rollers 78 and 80 are illustrated in FIG. 2 substantially parallel to one another and parallel to the plane of the drawing in FIG. 2. Although this is not absolutely necessary, when flat ribbon cables are used the use of deflection axes which do not differ too greatly from one another in terms of angles is advisable for the purpose of avoiding unnecessary rotations of the cable about its longitudinal axis.

That which has been said in connection with the cable 66 likewise applies to a hydraulic tube 86 which emerges on the other side of the industrial truck body 56 in relation to a longitudinal central plane of the industrial truck 50. Once it has emerged from the industrial truck body 56, the hydraulic tube 86 runs upwards to a first tube deflection roller 88. On this tube deflection roller 88, the hydraulic tube 86 is deflected approximately through 180° and then runs upwards to a second tube deflection roller 90 from where it runs upwards, after renewed deflection through approximately 180°, to a hydraulic oil connection 92 of the hydraulic cylinder 14 of the piston/cylinder unit 12.

In the profile (illustrated using dashed lines) of the hydraulic tube 86, said hydraulic tube 86 is hidden by the column arrangements 60c, 62c and 64c of the lifting mast 58 when viewed by the driver on the driver's platform, with the result that it does not disturb his vision.

In turn, the axes of rotation of the tube deflection rollers 88 and 90 are substantially parallel in the illustration. This is advantageous for the purpose of preventing unnecessary loading of the hydraulic tube 86 but is less necessary than in the case of a flat cable 66 since hydraulic tubes generally have circular-round cross sections.

Since the driver's platform can only be moved along the second lifting frame 64, it can easily be seen that a deflection of cables and tubes which is carried out in a lower region of the first lifting frame 62 is always below the driver's platform and thus always outside any field of vision of the driver. The driver therefore has a comparatively free field of vision in the main direction of travel HV.

1. Industrial truck having a load displacement means bearing a load-accommodating means such that it can be displaced, the industrial truck having, as the drive for displacing the load-accommodating means, a piston/cylinder unit which comprises as components a piston which can be extended out of a cylinder and withdrawn into this cylinder, a flexible force transmission means being provided for the purpose of transmitting a force from the piston/cylinder unit to a moveable component of the load displacement means or to the load-accommodating means itself and, for the purpose of deflecting said force transmission means, at least one deflection means for the force transmission means which deflects the force transmission means about a deflection axis being connected to one of the piston and cylinder, wherein at least one section of the deflection means, and preferably the entire deflection means, lies in the region of longitudinal extent of the piston/cylinder unit.

2. Industrial truck according to claim 1, wherein the deflection means for the force transmission means is provided such that the imaginary deflection axis, extended in the direction towards the piston/cylinder unit, of the deflection means for the force transmission means crosses or intersects the piston/cylinder unit.

3. Industrial tuck according to claim 1, wherein the deflection axis of the deflection means for the force transmission means runs substantially orthogonally with respect to the longitudinal axis of the piston/cylinder unit.

4. Industrial truck according to claim 1, wherein a head piece having a holding means for the purpose of holding the deflection means for the force transmission means is provided at that free longitudinal end of the piston which protrudes from the cylinder, said holding means preferably protruding substantially parallel to the longitudinal axis of the piston/cylinder unit towards the cylinder.

5. Industrial truck according to claim 1, wherein at least two deflection means for the force transmission means are provided on two opposing sides of the piston/cylinder unit.

6. Industrial truck according to claim 1, wherein the force transmission means is a chain, for example a slat chain, and the deflection means for the force transmission means is a chain deflection roller, in this case the axis of rotation of the chain deflection roller being the deflection axis.

7. Industrial truck, according to claim 1, having a lifting mast which bears a load-accommodating means such that it can be displaced and comprises a lifting stand fixed to the industrial truck frame and at least one lifting frame which is guided on the lifting stand and can be displaced in relation to said lifting stand in the longitudinal direction thereof, a cable for the purpose of transmitting control signals running between a control unit fixed to the industrial truck frame and an operating unit which is provided on a driver's platform which is guided on the lifting frame such that it can move in relation to said lifting frame, wherein the cable, starting from its end fixed to the industrial truck frame, runs upwards to a first cable deflection point on the lifting stand, from there downwards to a second cable deflection point on the lifting frame and from there upwards to the driver's platform.

8. Industrial truck, according to claim 1, having a lifting mast which bears a load-accommodating means such that it can be displaced and comprises a lifting stand fixed to the industrial truck frame, a first lifting frame which is guided on the lifting stand and can be displaced in relation to said lifting stand in the longitudinal direction thereof, and a second lifting frame which is guided on the first lifting frame in relation to said first lifting frame so as to move substantially in the longitudinal direction of the lifting stand, a cable for the purpose of transmitting control signals running between a control unit fixed to the industrial truck frame and an operating unit which is provided on a driver's platform which is guided on the second lifting frame such that it can move in relation to said second lifting frame substantially in the longitudinal direction of the lifting stand, wherein the cable, starting from its end fixed to the industrial truck frame, runs upwards to a first cable deflection point on the lifting stand, from there downwards to a second cable deflection point on the first lifting frame and from there upwards to a third deflection point on a movement part which moves in a fixed movement relationship with respect to the driver's platform and from there to the driver's platform.

9. Industrial truck according to claim 7, wherein the first deflection point and the second deflection point are provided such that the first deflection point is positioned above the second deflection point when the lifting frame has been extended completely in relation to the lifting stand.

10. Industrial truck according to claim 8, wherein the third deflection point is always positioned above the second deflection point.

11. Industrial truck according to claim 8, wherein the movement part is part of a piston/cylinder unit, which drives the driver's platform to move in relation to the second lifting frame, preferably the piston, which can move in relation to a cylinder fixed on the second lifting frame, of the piston/cylinder unit.

12. Industrial truck according to claim 11, wherein the movement part is the piston, which can move in relation to a cylinder fixed on the second lifting frame, of the piston/cylinder unit, a deflection means for the force transmission means being provided on said movement part, and a cable deflection axis of the third cable deflection point being substantially parallel to, preferably substantially colinear with respect to, the deflection axis of the deflection means for the force transmission means.

13. Industrial truck according to claim 8, wherein a tensile strain-relief device for the cable is provided between two successive cable deflection points, preferably between the second cable deflection point and the third cable deflection point, in particular when the cable is a flat cable.

14. Industrial truck according to claim 8, wherein a cable deflection roller is provided at at least one, preferably at all, of the cable deflection points.

15. Industrial truck having a lifting mast which bears a load-accommodating means such that it can be displaced and comprises a lifting stand fixed to the industrial truck frame, a first lifting frame which is guided on the lifting stand and can be displaced in relation to said lifting stand in the longitudinal direction thereof, and a second lifting frame which is guided on the first lifting frame in relation to said first lifting frame so as to move substantially in the longitudinal direction of the lifting stand, a cylinder of a piston/cylinder unit further being fixed on the second lifting frame, and the piston which can move in relation to said cylinder being coupled so as to provide motion transfer to a driver's platform which is guided on the second lifting frame such that it can move in relation to said second lifting frame substantially in the longitudinal direction of the lifting stand, a flexible working fluid line conveying working fluid running between a fluid conveying unit fixed to the industrial truck frame and the cylinder, wherein the working fluid line, starting from its end fixed to the industrial truck frame, runs upwards to a first line deflection point on the lifting stand, from there downwards to a second line deflection point on the first lifting frame and from there to the cylinder.

16. Industrial truck according to claim 15, wherein the lifting mast comprises in each case at least two column arrangements running parallel to one another substantially in the longitudinal direction of the lifting mast, the cable being arranged in the region of a column arrangement and the working fluid line in the region of another column arrangement, preferably hidden at least in sections by the respective column arrangements, when viewed by the industrial truck driver.

17. Industrial truck according to claim 7, wherein the first deflection point and the second deflection point are provided such that the first deflection point is positioned above the second deflection point when the lifting frame has been extended completely in relation to the lifting stand.

18. Industrial truck according to claim 7, wherein a tensile strain-relief device for the cable is provided between two successive cable deflection points.

19. Industrial truck according to claim 7, wherein a cable deflection roller is provided at at least one of the cable deflection points.
